(19) United States
(12) Patent Application Publication
(10) Pub. No.: US 2021/0162346 A1
(43) Pub. Date: Jun. 3, 2021

(54) LAYERED ELECTROOSMOTIC STRUCTURE AND METHOD OF MANUFACTURE

(71) Applicant: Osmotex AG, Thalwil (CH)

(72) Inventor: Trond Heldal, Luzern (CH)

(73) Assignee: Osmotex AG, Thalwil (CH)

(21) Appl. No.: 16/769,515

(22) PCT Filed: Dec. 5, 2018
(86) PCT No.: PCT/EP2018/083682

§ 371 Date: Jun. 3, 2020

(30) Foreign Application Priority Data
Dec. 5, 2017 (GB) 1720257.3

(51) Int. Cl. B01D 61/42; B32B 3/12; B01D 69/12; B32B 3/26

(52) U.S. Cl. CPC B01D 61/427; B32B 3/12; B01D 69/12; B32B 3/266; B01D 2313/345; B32B 2255/20; B32B 2307/202; B32B 2307/206; B32B 2255/02; B32B 2535/00; B01D 2325/26

(57) ABSTRACT

A layered electroosmotic structure for transporting fluid by electroosmotic transport includes a porous layer; a first electrode located on a first side of the porous layer; and a second electrode located on a second side of the porous layer. The first electrode may include a first surface that faces the porous layer, wherein the first surface of the first electrode includes a region that is electrically insulating. The first electrode and/or the second electrode may not be in electrical contact with an edge region of the porous layer. Methods of manufacturing the layered electroosmotic structures are also provided.

The invention relates to layered electroosmotic structures and methods of manufacturing a layered electroosmotic structure or panel.

Electroosmosis (EO) is a known technique for transporting fluids through membranes. Structures for effecting fluid transport by electroosmosis typically comprise an EO membrane located between two conductive electrodes. When a voltage is applied between the electrodes, the result is an electric current through the EO membrane and thus electroosmotic moisture transport through the EO membrane.

It is crucial that there is no low electrical resistance (relative to the resistance of the EO membrane) direct contact between the conductive electrodes. This is because this would result in a large proportion of the current going between the conductive electrodes without passing through the EO membrane, thus reducing or eliminating the EO transport.

In a first aspect the present invention provides a layered electroosmotic structure for transporting fluid by electroosmotic transport, the layered structure comprising: a porous layer, wherein the porous layer is a non-conductive electroosmotic layer; a first electrode located on a first side of the porous layer; and a second electrode located on a second side of the porous layer; wherein the first electrode comprises a first surface that faces the porous layer, wherein the first surface of the first electrode comprises a region that is electrically insulating.

In a second aspect the present invention provides a method of manufacturing a layered electroosmotic panel for transporting fluid by electroosmotic transport, the method comprising: providing a layered electroosmotic structure comprising: a porous layer; a first electrode layer located on a first side of the porous layer; and a second electrode located on a second side of the porous layer; wherein the first electrode comprises a first surface that faces the porous layer, wherein the first surface of the first electrode comprises a region that is electrically insulating; and cutting the layered structure at the region that is electrically insulating of the first surface of the first electrode to form the layered electroosmotic panel.

In a third aspect the present invention provides a layered electroosmotic structure for transporting fluid by electroosmotic transport, the layered structure comprising: a porous layer, wherein the porous layer is a non-conductive electroosmotic layer; a first electrode located on a first side of the porous layer; and a second electrode located on a second side of the porous layer; wherein the first electrode and/or second electrode is not in electrical contact with an edge region of the porous layer and the first electrode and/or second electrode is in electrical contact with the porous layer at a non-edge region.

In a fourth aspect the present invention provides a method of manufacturing a layered electroosmotic panel for transporting fluid by electroosmotic transport, the method comprising: providing a porous layer, wherein the porous layer is a non-conductive electroosmotic layer; providing a first electrode; and providing a second electrode; locating the first electrode on a first side of the porous layer and locating the second electrode on a second side of the porous layer to form a layered electroosmotic structure, wherein the first electrode and/or second electrode is not in electrical contact with an edge region of the porous layer and the first electrode and/or second electrode is in electrical contact with the porous layer at a non-edge region.

Normally, textiles are delivered on a roll and cut to suitable panels for producing a product such as an item of clothing or other product. If the textile consists of multiple layers (e.g. a waterproof textile that comprises an outer textile with a waterproof membrane), the layers are bound together already on the roll material and cut to appropriate sized panels for the desired application.

However, when cutting a multilayer material one will have a cutting edge through all of the layers. In the case of a layered EO structure, cutting the EO structure with electrically conductive electrodes may give the danger of direct electrical contact between the conductive electrodes at the cut edges, which would be detrimental to its function as described.

As a result, it is desired for the first electrode and/or second electrode to not be in electrical contact with the porous layer at an edge region, e.g. at a cut edge.

Conductive material of the first electrode and/or the second electrode may be spaced from an edge (i.e. cut edge) of the porous layer, i.e. conductive material of the first electrode and/or second electrode is not in contact with the porous layer at the edge and/or edge region of the porous layer.

As a result, the risk of there being a direct electrical contact between the conductive electrodes at the edges may be reduced.

The electroosmotic structure may be produced by first separately cutting each of the porous layer and first and second electrically conductive electrodes. The porous layer may be cut to a larger size than one or both of the electrodes. Thus the porous layer may be larger, i.e. have a greater width and/or length, than one or both of the electrodes.

The three layers may then be fixed, e.g. glued, together. The larger porous layer will extend beyond the edges of the electrically conductive electrodes such that the electrodes are spaced from an edge of the porous layer. As a result, the first electrode and/or second electrode are not in electrical contact with the porous layer at the edge region. This may thus minimise the risk of direct contact between the electrodes.

It has been realised that by having a porous layer that is larger than at least one of the electrodes, the risk of a short circuit between the electrodes may be reduced.

This process of manufacture of such fabrics requires the cutting, careful alignment and bonding of at least three separate layers. This process may be expensive and time consuming and thus is not suitable for all applications. For example, whilst it may be useful and sufficient in small or medium volume manufacturing applications, it may not be appropriate in high volume manufacturing applications.

It has been further realised by the inventors that by having at least one of the electrodes comprise a region of the surface that faces the porous layer that is electrically insulating it is possible to reduce the risk of there being a short circuit between the two electrodes whilst being able to mass produce the layered structure (if that is desired). This is because the layered electroosmotic structure may be cut at a location that is within the region that is electrically insulating of the electrode such that at the resulting cut edge there is a reduced chance of there being a short circuit formed between the conductive parts of the two electrodes. This is because the insulating region may act to space the conductive part of the electrode from an edge of the porous layer. Thus, this may mean that the electrode is not in electrical contact with the porous layer at an edge region of the porous layer. This may thus minimise the risk of there being a short circuit between the electrodes.

The insulating region may act to space the conductive part of one or both electrodes from a conductive part of the other electrode. This may reduce the risk of conductive parts of the electrodes coming into contact with each other and thereby creating a short circuit.

The distance (e.g. in a thickness direction) between conductive parts of the electrodes may be greater at one, more or all of the edge regions of the electroosmotic structure compared to the distance (e.g. in a thickness direction) between conductive parts of the electrodes at a non-edge region (e.g. an active region where electroosmotic transport occurs when a voltage is applied between the electrodes).

By there being no electrical contact may mean that when a voltage is applied between the electrodes, no current (or substantially less) current flows at that region compared to regions where there is electrical contact.

In a broad aspect the present invention may provide a layered electroosmotic structure, the layered structure comprising a porous layer, a first electrode and a second electrode, wherein at least one of the electrodes is arranged so as to minimise the risk of a short circuit between the electrodes at an edge of the porous layer. The invention may provide a method of manufacturing such an electroosmotic layer.

Having the conductive material of the first electrode and/or second electrode spaced from an edge of the porous layer may mean that the electrode is not in electrical contact with the edge of non-conductive porous layer. Thus, it may mean that a conductive portion of the first electrode and/or a conductive portion of the second electrode is spaced from an edge of the porous layer.

The feature of the first electrode and/or second electrode not being in electrical contact with an edge region of the porous layer may be achieved by having a first surface of the first or second electrode that comprises a region that is electrically insulating, wherein that region is at an edge/edge region of the porous layer.

The conductive material of the first and/or second electrode may be spaced from an edge of the porous layer in a thickness and/or lateral direction.

If the conductive material of the electrodes is not spaced from an edge of the porous layer the conductive material of each of the electrodes has a greater chance of coming into contact with each other such that a short circuit may occur.

For example, in the case that the electrode has a first surface that comprises a region that is electrically insulating and at the same region has a material that is conductive (i.e. above the electrically insulating part), the conductive material may be spaced from the porous layer at that region by the thickness of the electrically insulating region facing the porous layer.

The edge region may be an area at the edge of the porous layer on the surface that faces the respective electrode.

Having the first and/or second electrode in electrical contact with the porous layer at a region may mean that when a voltage is applied between the electrodes, a current can flow between the electrodes through the porous membrane at that region.

Having the first and/or second electrode in electrical contact with the porous layer at a region may mean that a conductive material of the first and/or second electrode is in contact with the porous membrane, e.g. direct contact (including contact with a fixing means, such as adhesive (e.g. a porous glue) therebetween), i.e. with no other layers therebetween.

The feature of the first electrode and/or second electrode not being in electrical contact with an edge region of the porous layer may be achieved by the porous layer being larger than the first and/or second electrode. For example, the porous layer may have a greater width and/or length than the first and/or second electrode.

The first electrode and/or second electrode may not be in electrical contact with any edge region of the porous membrane. In other words, around the entire periphery of the porous membrane there may be no electrical contact between the first and/or second electrode and the porous membrane.

This may be achieved by the first and/or second electrode comprising a region on the surface that faces the porous layer that is electrically insulating around the entire periphery where the first electrode and second electrode are at, or near the edge (e.g. within 1 cm, 0.5 cm or 0.1 cm etc. of the edge) of the porous membrane and/or by the porous membrane extending beyond the edge of the first and/or second electrode (e.g. if the porous membrane is wider and/or longer than the first and/or second electrode).

The layered structure may comprise an insulating frame that is between the conductive material of the first electrode and the an edge region of the porous layer and/or an insulating frame that is between the conductive material of the second electrode and the edge region of the porous layer. The insulating frame(s) may only extend around the periphery of the porous layer. The insulating frame(s) may have a central aperture where there is no material. Thus, it may be that there is only an insulating region at the edges of the structure. In the centre, the conductive material of one or both electrode may be in direct contact with the porous layer.

The electroosmotic structure may be formed by layering up a porous layer with an insulating frame on one or each surface of the porous layer and then a conductive layer on each side to form the electrodes. The layers may then be fixed together, e.g. by an adhesive such as a porous glue. The layers may be compressed together such that the conductive material of the electrode(s) contacts the porous layer in the central aperture of the respective insulating frame.

As an example, if the insulating frame is the same size as the porous layer and the insulating frame is 1 cm wide between its edge and central aperture on each side, the conductive material of the electrode may not contact the porous layer at a 1 cm wide edge region where the insulating material of the frame is present.

The layered structure may be referred to as an electroosmotic structure, device or membrane.

The structure may for example be, or be part of, an electroosmotic pump and/or an electroosmotic textile.

The porous layer may be a porous membrane. The porous layer may be an electroosmotic (EO) layer, e.g. an EO membrane. The porous layer may be non-conductive.

The porous layer may be a layer which effects electroosmotic transfer of fluid, e.g. liquid, therethrough when a voltage is applied across the layer.

The porous layer may be between 10 to 100 microns thick, for example, between 20 and 80 microns thick or about 50 microns thick.

The porous layer may have porosity in the range 1 to 80%, and pore size from 1 up to 500 nm, 50 to 150 nm or about 100 nm. For example the porous layer may have a pore size of 1 to 10 nm. This for example may be the case for materials having their pore size defined by a polymer or other material microstructure.

The porous layer may for example be a track-etched membrane, or a membrane produced by phase inversion like nanoporous membranes from the companies Millipore or Pall (i.e. nanoporous grades of Millipore/Pall membrane).

The porous layer may be made for example from aminated or sulfonated PET or PES membranes.

The first and/or second electrodes may be referred to as electrode layers. The first and/or second electrodes may be referred to as electrically conductive layers. The electrodes may comprise conductive material. The electrodes may be such that a voltage difference can be applied between the electrodes across the porous layer that causes charge to flow through the porous layer.

The first and/or second electrodes may be porous. This is so that fluid transported through the porous layer can pass through the electrodes.

The first and/or second electrode may be textile electrodes, i.e. electrodes that comprise a textile/fabric material.

The pore size (e.g. average pore size) of the electrodes may be greater than the pore size (e.g. average pore size) of the layered structure so that they do not provide a significant resistance to the flow of fluid through the layered structure.

The electrodes may be textiles. The electrodes may be capacitive or redox couple electrodes. The electrodes may be capacitive (“activated”) carbon electrodes or other high surface area electrodes made of carbon or another material. The electrodes may be reversible or polarizable electrodes.

The second electrode may also (additionally or alternatively) comprise a surface facing the porous layer that has a region that is insulating. Thus, the following described features of the electrode may be present in one electrode or in both electrodes.

In the case that both electrodes have an insulating region, the region that is electrically insulating on the first electrode may correspond in location or at least partially overlap the location where the region that is electrically insulating of the second electrode is located. This may mean that if the structure is cut at a location where the regions that are electrically insulating on each of the electrodes are located that extra security is provided against the conductive parts of the electrodes coming into contact.

The region that is electrically insulating may be at, i.e. adjacent to, a cut surface of the layered structure. Thus, the layered structure may comprise one or more cut edges (i.e. an edge that is formed by dividing the layered structure from a larger layered structure) and the insulating region of the first and/or second electrode that faces the porous layer may be at the edge region of the porous layer adjacent to each of the one or more cut edges.

The region that is electrically insulating may provide a greater resistance to the flow of charge than the porous layer.

The insulating region may be less conductive than the porous layer (e.g. the porous layer when wetted and thus arranged to transport liquid, i.e. than the porous layer in use). This is so that if the insulating region of one electrode is in contact with the other electrode it does not provide an electrical path of less resistance than through the porous layer.

The porous layer may become conductive when wetted. The conductivity of the wetted porous layer may be the same conductivity as the wetting liquid or more, such as up to at least 10 times the conductivity of the liquid.

The porous layer may for example (depending on the wetting liquid) have a resistivity that is 10 to 1000 Ohm per square cm. The insulating region may have a resistivity that is in the Mega Ohm range.

The first surface of the first electrode and/or second electrode may comprise a region that is electrically conductive and the region that is electrically insulating may provide a greater resistance to the flow of charge than the region that is electrically conductive. The region that is electrically conductive may be in electrical contact with the porous layer. This may be at a non-edge region.

The insulating region may prevent the flow of current at that location.

The insulating region may be provided by there being no conductive material on the surface of the electrode at that region. For example, there may be a non-conductive material and/or no material at that region.

The insulating region may space the conductive part (if present) of the electrode in that region from the porous layer. In other words, the distance between the conductive part of the electrode and the conductive part at the other electrode may be greater at the location of the insulating region compared to a non-insulating region. This is so that the chance of any conductive part of the electrode coming into contact with a conductive part of the other electrode when the structure is cut in that region is reduced.

Conductive material of the first and/or second electrode may be spaced (e.g. in the thickness direction) from the porous layer at an edge region by a greater distance than at a non-edge region.

The surface of the electrode facing the porous layer may be defined as the plane that extends through the parts of the electrode closest to the porous layer. It is for this reason that the surface may comprise regions with no material, i.e. a gap or a void.

The non-conductive material, if present may be referred to as an insulating material. The insulating material may provide an electrical barrier that reduces the chance of current flowing directly between the two electrodes without passing through the porous membrane.

The non-conductive material may be sufficiently insulating such that when a voltage is applied across the two electrodes and the non-conductive region of one electrode contacts the other electrode, current will still flow at least partially preferentially through the porous layer rather than via the direct connection between the non-conductive material of one electrode and the other electrode.

The surface of the electrode(s) comprising an electrically insulating region may be provided by the electrode comprising non-conductive material that is attached to (e.g. in contact with and/or fixed to) conductive material.

The electrode(s) may comprise conductive and non-conductive material. The electrodes may comprise a plurality of layers such as a layer of conductive material and a layer of non-conductive material.

For example, the non-conductive material may be a layer of non-conductive material that is fixed (e.g. laminated/bonded) to a conductive layer. The layer of non-conductive material may have apertures therethrough so as to expose the conductive material of the electrode underneath.

The non-conductive material may be a non-conductive coating that is coated onto conductive material at regions of the surface that in use faces the porous layer. The non-conductive material may be a non-conductive coating that is coated onto the porous layer to form insulating regions.

The non-conductive coating may be applied selectively using a screen/mask.

Areas between where the non-conductive coating is applied may be coated with a capacitive and/or conductive coating such as a carbon coating.

The conductive and non-conductive regions on the surface of the electrode that faces the porous layer may be obtained by selectively applying a capacitive and/or conductive coating onto a conductive textile, and coating areas between said capacitive and/or conductive coating with a non-conductive coating (e.g. polyurethane). The coatings may be applied using screen printing or another technique involving templates or screes, or with programmable precision coating equipment.

The non-conductive material may be a continuous layer with one or more apertures therethrough. For example the non-conductive material may be a frame. Such a frame may provide an electrically insulating region around the entire periphery of the electroosmotic structure.

The one or more apertures in the non-conductive layer may allow the conductive material of the electrode to be in electrical contact with the porous layer.

The non-conductive layer may have a low compressibility. The non-conductive layer (e.g. a frame) may provide a physical spacer between the porous layer and the conductive part of the electrode (or a carbon coating of the conductive part if such a coating is present).

The non-conductive layer may have a thickness between 10 microns to 0.3 mm, such as 10 microns to 100 microns or 0.1 mm to 0.3 mm. The non-conductive layer may be designed so as to not become less than 0.05 mm upon a normal pressure of 10 bar.

The non-conductive layer may be an impermeable film. It may be acceptable for the non-conductive layer to be impermeable as it does not cover the entire surface of the electrode and thus even if impermeable, moisture transport can still occur due to the presence of the permeable conductive regions. The non-conductive layer may be made from a polymer such as polyurethane. The non-conductive layer may be a non-conductive textile.

The non-conductive layer may be adhered, e.g. glued, to the conductive layer.

The non-conductive layer may be attached to the conductive layer at the same time as the process to attach the porous layer between the electrodes.

The non-conductive material may be an additional layer to the conductive layer. Thus the electrode may be made up of a plurality of layers, such as two or more.

The electrode(s) may comprise protrusions of conductive material that extend towards the porous layer. There may be gaps/voids around the protrusions. This is so that the surface of the electrode(s) that faces the porous layer may have insulating regions formed by the gaps between the protrusions of conductive material. These gaps may space the conductive material at that region from the other electrode such that if the structure is cut at that region the chance of the conductive part of one electrode coming into contact with the conductive part of another electrode is reduced.

The electrode(s) may have opposite surfaces (i.e. a first surface that in use faces the porous membrane and a second surface that in use faces away from the porous layer) that are different. For example, one surface may comprise regions that are insulating and the opposite surface may have no regions that are insulating. The electrode(s) may be referred to as a two face fabric and/or a double face fabric.

The electrode(s) may comprise multiple conductive and non-conductive regions. The conductive regions may be electrically connected at the side of the electrode facing away from the porous layer. This may allow the electroosmotic panels to be cut out panels comprising multiple conductive regions. This may provide many possibilities for shaping the panels.

The layered structure may be designed to be cut through the layered electroosmotic structure at regions that have the first or second electrode having a region that faces the porous layer that is electrically insulating.

The region where the surface of the first and/or second electrode that faces the porous membrane is insulating may be regarded as a cutting zone.

Alternatively, the conductive regions of the electrodes may not be electrically connected. In this case, the panels that can be cut from the structure may comprise a single conductive region surrounded by a non-conductive region. The number of panels that can be cut from an EO structure may equal the number of conductive regions (i.e. conductive regions facing the porous membrane) that the electrode of the structure comprises.

The conductive and non-conductive regions that are present on the surface that faces the porous membrane may extend through the thickness of the electrode. This means that the opposite surface that in use faces away from the porous membrane has corresponding and/or complementary conductive and non-conductive regions to the surface that faces the porous layer. The complementary regions on opposite surfaces of the electrodes may have a different area to each other.

The conductive regions and non-conductive regions (e.g. electrically insulating regions) may be regions that are comparatively, to each other, conductive and non-conductive. Thus the conductive region may have a lower electrical resistance than the non-conductive regions.

When a voltage is applied between the electrodes, all, or the majority of, the electroosmotic transport through the porous layer may occur where the conductive region(s) on the first and/or second electrode faces the porous membrane.

The electrode(s) may be formed from conductive and non-conductive fibres (i.e. yarns). The electrode(s) may thus be textile electrode(s).

The conductive and non-conductive fibres may be interwoven.

The non-conductive fibres may provide the region that is insulating on the electrode(s). For example, the fibres may be woven so that the surface of the electrode that faces the porous layer comprises one or more insulating regions formed from non-conductive fibres and one or more conductive regions formed from conductive fibres.

The electrode may comprise zones of a certain width with the conductive fibre in warp and weft.

The conductive fibre and non-conductive fibre may be woven together such that the location of the conductive yarn shifts from one face of the fabric to the other. This may result in regions on one surface that consist of non-conductive fibres, i.e. regions that are insulating.

The conductive regions may all be electrically connected. However, the electrical connections, e.g. conductive fibres, connecting the conductive regions may be spaced from the porous layer by a gap or non-conductive material, e.g. non-conductive fibres, in the insulating region(s).

The region that is insulating facing the porous membrane (from one or both electrodes) may extend from one edge to a second edge of the electrode(s) and/or layered EO structure. This is so the structure can be cut from one edge to another edge whilst being in a location in which an insulating region faces at least one surface of the porous layer. Thus, the entire cut edge of a electroosmotic structure may be along a region that is insulating facing the porous membrane (from one or both electrodes).

The surface of the electrode that faces the porous layer may not entirely be insulating. This is so that when a voltage is applied between the electrodes a current can still pass through the porous layer from one electrode to the other.

The surface of the electrode that faces the porous layer may comprise regions without non-conductive material.

The one or more regions without non-conductive material may be located within, e.g. entirely surrounded by, a region of non-conductive material. This is so that there may be a continuous region with non-conductive material facing the porous layer through which the structure may be cut.

Any cut edge of a produced electroosmotic structure may be along a region with non-conductive material facing the porous layer.

The regions without non-conductive material may comprise conductive material. For example, the surface could be made up of one or more regions of conductive material and one or more insulating regions that may be formed of a non-conductive material and/or a gap.

The surface of the first and/or second electrode that faces the porous layer may comprise a region that allows current to flow through the porous layer. The region that allows current to flow (e.g. the conductive region) may be surrounded by insulating region(s). Thus the structure may comprise a plurality of patches wherein each patch may comprise an electrode with a surface facing the porous layer that has a region through which current can flow surrounded by a region through which current cannot flow. This means if the structure is cut at the boundary between two patches, at the cut boundary of the patches the chance of an electrically conductive part of one electrode coming into contact with an electrically conductive part of the other electrode is reduced.

The first and/or second electrode may be made of conductive and non-conductive material wherein the surface that faces the porous layer has regions formed of the conductive material and regions formed of the non-conductive material.

The regions without non-conductive material may comprise no material, i.e. may be a gap. This may for example be formed when the electrode is formed of a non-conductive layer with apertures therethrough (e.g. a frame) is attached to a conductive layer. The apertures provide the areas of the surface where there is a gap.

Each electrode may comprise a continuous electrically conductive path within the layer. Each electrode may be arranged so that all of the electrically conductive parts are electrically connected.

Each electrode may be arranged so that when a voltage is applied between the electrodes a voltage is applied across the porous layer so as to cause electroosmotic flow through the layer. Liquid transport may occur through the porous layer at regions where the surface of the electrode(s) facing the porous layer is conductive and/or not insulating.

The electrically conductive path through the electrode may discontinuous on the surface (i.e. plane through the parts closest to the porous membrane) facing the porous membrane.

The method may comprise fixing (e.g. laminating) the porous layer between the first and second electrodes to form the layered electroosmotic structure.

The porous layer may be larger (i.e. have a greater width and/or length) than one or both of the electrodes such that when layered electroosmotic structure is formed the first electrode and/or the second electrode can be spaced from (i.e. in a lateral direction) the edges of the porous layer. This means that the first electrode and/or second electrode is not in electrical contact with an edge region of the porous layer. This minimises the risk that the electrodes can come into electrical contact with each other at the edge of the porous layer and thus reduces the possibility of there being a short circuit.

The method may comprise cutting (i.e. dividing) the structure into panels by cutting (i.e. dividing) at locations where a region that is insulating and faces the porous layer of at least one of the electrodes is located. In other words, the electrodes and the EO porous layer may be attached together and then cut into smaller panels. This may allow the EO structure to be produced using a standard textile lamination technique such as a roll process. Thus the cutting in this case is through all of the layers simultaneously, i.e. through all of the layers in a single cutting operation.

The non-cut edges, e.g. edges of the larger formed electroosmotic structure, may have the first or second electrode not in electrical contact with the edge region, either by virtue of the porous layer extending beyond the edge of one or both of the electrodes (such that the conductive portion of one or both of the electrodes is laterally spaced from the edge of the porous membrane), and/or by virtue of the first electrode and/or second electrode having a region that faces the porous layer at or near the edge that is electrically insulating (such that the conductive portion of one or both of the electrodes is transversely spaced (i.e. spaced in the thickness direction) from the edge of the porous membrane).

The region that is insulating may define a cutting zone. This may be a zone in which at least one of the electrodes is not conductive (i.e. insulating) on its surface that faces towards the porous layer.

Thus the structure may comprise cutting zones in which at least one of the electrodes is electrically insulating (e.g. not conductive) on its surface towards the porous layer. This allows the formed structure to be cut to the desired size for a particular application without risk of a short circuit between the electrodes at the cut edge.

The layered electroosmotic structure may be cut to the right size and shape to form an electroosmotic panel. The panel may be incorporated into an article such as a garment construction.

The layered electroosmotic structure may be cut by a cutter such as a laser cutter or a gerber (knife) cutter. This may be performed in a simple automated process with standard equipment.

The present invention may allow a method to manufacture the EO panels using a roll process. The roll process may be as is used for conventional textiles. Thus the layered electoosmotic structure may be formed using roll processing. Such a method may comprise fixing together (e.g. laminating) the porous layer between the two electrodes to form a layered electroosmotic structure. The porous layer may extend beyond (e.g. be larger than) one or both of the electrodes at the edges of the layered electroosmotic structure. The layered electroosmotic structure may subsequently be cut. The cut may be in the region that is insulating. This may minimise the risk of there being a direct electrical contact between the electrodes at the edges.

The roll process may comprise providing one or more rolls with material to provide the porous layer, one or more rolls with material to provide the first electrode, and one or more rolls with material to provide the second electrode. The roll(s) of material to produce the porous layer may be wider than the roll(s) of material to produce the electrodes.

Each electrode may for example be formed from material from two rolls such as a roll with conductive material and a roll with a non-conductive frame to provide the insulating regions.

There may also be additional rolls to provide additional layers such as thermally insulating or waterproof layers if present in the final structure.

Material from each roll may be attached together such as by passing the layers of material through a lamination roller and/or using adhesive between the layers. This may form a layered electroosmotic structure. This structure can be cut into electroosmotic panels. This may for example be cut using a laser cutter. The layered structure may be cut only at locations in which at least one of the electrodes has a region that is insulating facing towards the porous layer.

The roll process may be a roll to roll process in which layers from multiple rolls are laminated together and then put onto another roll for storing and/or transportation before cutting.

Cutting the electroosmotic layered structure may result in two or more electroosmotic panels. Each electroosmotic panel may comprise a cut edge at which at least one of the electrodes has a region that is electrically insulating.

The layered electroosmotic structure and/or layered electroosmotic panel may be arranged so that when a voltage is applied between the electrodes it results in an electric current and/or electroosmotic fluid transport through the porous layer.

One or both electrodes may comprise a coating that reduces or prevents leakage currents. One or both electrodes may comprise a coating that causes the electrodes to be capacitive electrodes. The coating may allow EO pumping to be performed at low energy and voltage (0.1-1.2 V as opposed to minimum 1.2 V for metal electrodes), and/or to suppress or eliminate undesired electrochemistry.

For example, one or both electrodes may comprise a carbon coating. The carbon coating may be coated on the surface of the electrode that faces the porous layer. In the case that the electrode comprises a non-conductive layer (e.g. with apertures therethrough) and a conductive layer, the carbon coating may be located between the conductive layer and the non-conductive layer. The carbon coating may for example be coated onto the conductive layer.

The carbon coating may at least partially contact a conductive part of the electrode. The carbon coating may coat the entire conductive part of the electrode that faces the porous layer.

The coating, e.g. carbon coating, may be provided over the entire surface of the electrode that faces the porous layer. Thus, the coating may be present on both the conductive and non-conductive regions of the surface of the electrode(s) that faces the porous layer. The conductivity of the carbon coating on regions that are insulating may be too low to cause significant leakage currents.

The carbon coating may have a conductivity that is small compared to the conductivity of the conductive parts of the electrode. The surface resistance of the conductive coating may be much higher when coated onto a non-conductive material such as in the region which is insulating compared to when coated onto a conductive region. For example, a carbon coating containing 20% carbon and 80% binder showed a surface resistance of 0.31 Ohm square when coated on a highly conductive textile, but as much as 400 Ohm square when coated on a non-conductive textile. As a result, direct contact between carbon coated layers at the edges may not pose a problem as long as the underlying material is not conductive in the same area.

The method of manufacturing the structure may comprise providing, such as depositing, a coating such as a carbon coating on one or both of the electrodes. The carbon coating may be provided on the side of the electrode that faces the porous membrane.

The carbon coating may be deposited onto the electrode before the material is put onto a roll for roll processing.

The carbon coating may cover both the insulating regions and the non-insulating regions.

The electroosmotic layered structure may comprise a carbon coating on one or both sides of the porous layer.

The electroosmotic membrane may comprise one or more additional layers. These for example may comprise additional inner and/or outer fabrics. These fabric layers may be located on the side of one or both of the electrodes that is opposite to the porous layer.

These additional layers may have additional functions to the EO function of the porous layer and electrodes. For example, the additional layers may have a thermal insulating and/or waterproofing function. An additional layer may be provided on one side the EO structure that has a waterproof function and a second additional layer may be provided on the other side of the EO structure that has a thermal insulation function.

The additional layer(s) if present may have holes in it so that an electrical connection can be made to the electrode underneath the additional layer. For example, the structure may comprise additional inner and/or outer textile layers that cover the electrode(s) that may have perforations to enable the affixing of electrical contacts to the underlying electrode(s). The perforations may also mean that the additional layers do not hinder moisture transport out of the structure.

The present invention may provide a method of using the layered structure to transport fluid. A voltage may be applied across the layered structure, e.g. across the porous layer, using the electrodes. The present invention may comprise a method of effecting electroosmotic transport using the layered structure described herein (including one or more of the described optional features).

The layered structure may be used in clothing, sports equipment, vehicle and building interior materials to provide a means of effective fluid transport. The layered structure may alternatively be used as a medical textile, e.g. for bed sore prevention or treatment, wound treatment etc. The structure may be used to remove condensation or other moisture in electronic, mechanical and medical devices. The structure may be used as an actuator in a mechanical or fluidic system. This is a list of exemplary applications but is by no means exhaustive.

The cut EO panels may be integrated into a product such as a garment, furniture, automotive interior, mattress, shoe, or other item or structure. The minimum required layers to form an operating panel may be the electrodes with at least one having the above described insulating region(s) and the EO porous layer. In typical applications there may be more layers. These additional layers may be added as a separate step after the EO panel has been formed and cut or as part of the EO layered structure production. For example, in a jacket, a five layer EO panel (i.e. made of the porous layer, two electrodes and two outer layers) could constitute a part of the garment, e.g. the upper back, or the three layer EO panel (i.e. made of the porous layer and two electrodes) may be integrated at some position between existing inner and outer fabric materials in the jacket. In some cases the panels may be produced by one supplier, and the customer (e.g. jacket manufacturer) may add the additional inner and outer layers onto the panels.

The present invention may provide an electroosmotic textile and/or an electroosmotic pump that comprises the layered structure described herein.

The system (e.g. pump or textile) may comprise a power source. The power source may be arranged to apply a voltage across the layered structure. The power supply may provide AC or DC voltage.

In a broad aspect the present invention provides a layered electroosmotic structure for transporting fluid by electroosmotic transport, the layered structure comprising: a porous layer; a first electrode located on a first side of the porous layer; and a second electrode located on a second side of the porous layer; wherein the structure is arranged so that when it is cut charge cannot flow between the electrodes at the cutting (i.e. cut) edge without going via the porous layer.

This structure may have one or more of the above described features and/or may be manufactured by a method comprising one or more of the steps described above.

The present invention may minimise the risk of there being a short circuit between the electrodes of an electroosmotic structure. Further, certain aspects of the present invention may mean that the time consuming process of cutting, assembling and laminating each layer to produce the EO panel is not necessary. In a typical case, this time consuming process would include the two electrode layers and a porous EO membrane, plus an inner and outer textile layer, in addition to a layer of glue between each layer to be laminated, and with each layer cut to different sizes and carefully aligned before laminating which could take up to 12 minutes per panel. Instead manufacture based on standard methods used in the textile industry may be made viable. This may make making EO textiles viable for industrial mass production. Instead of manual labour of for example an estimated 12 minutes per panel, the roll process which may be facilitated by the present invention may run automatically and may produce up to several panels a minute.

Certain preferred embodiments of the present invention will now be described by way of example only with reference to the accompanying drawings, in which:

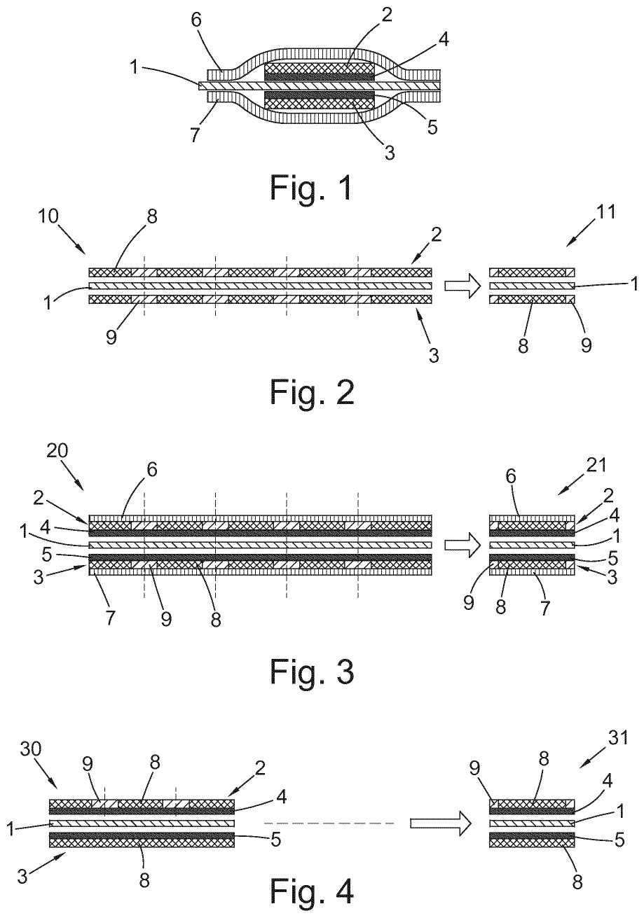

FIG. 1 shows an electroosmotic structure;

FIGS. 2, 3, 4, 5, 7 and 8 show various electroosmotic structures and panels;

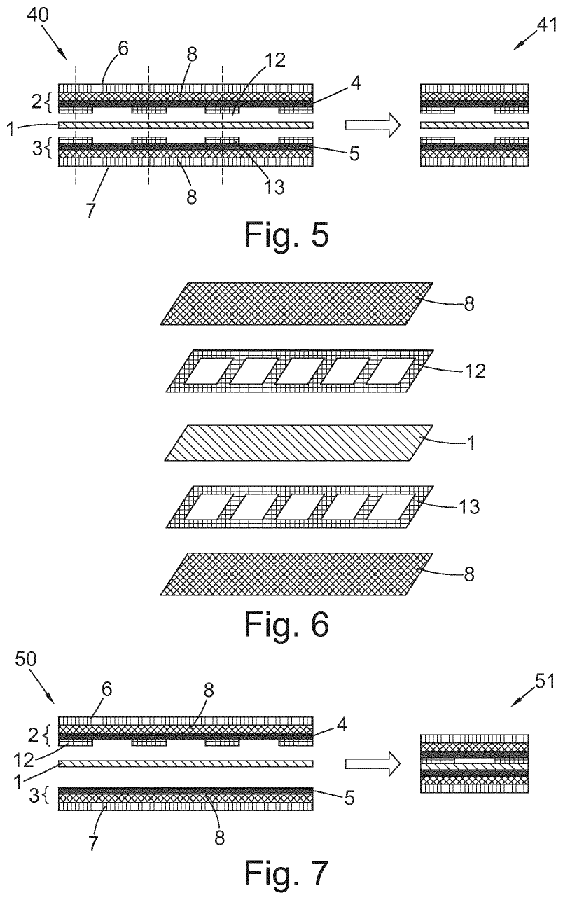

FIG. 6 shows an exploded version of some of the components of the structure of FIG. 5;

FIGS. 9 and 10 show an exemplary electrode;

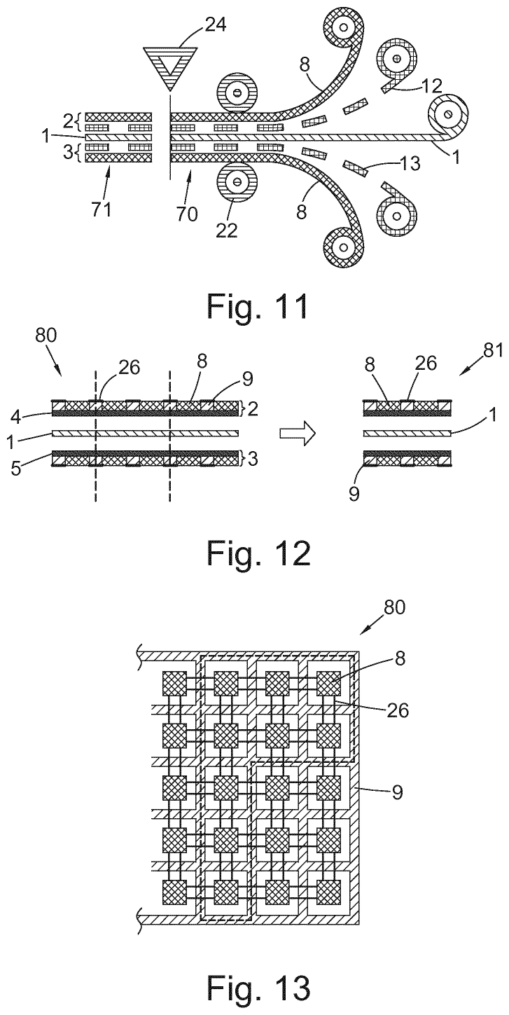

FIG. 11 shows schematically a method of manufacturing the structure and panels; and

FIGS. 12 and 13 illustrate an electroosmotic structure that is to be cut into a panel with multiple conductive regions that are electrically connected

FIG. 1 shows an electroosmotic device that comprises an electroosmotic (EO) membrane 1, and a first and second electrode 2, 3 either side of the membrane 1. The device also comprises a carbon coating 4, 5 on each of the electrodes 2, 3. On the outer surfaces are additional layers 6, 7 that may have additional functions such as providing thermal insulation and/or waterproofing.

When a voltage is applied to the electrodes 2, 3 across the electroosmotic membrane 1 fluid will flow through the membrane 1 by means of electroosmosis.

This structure may be formed by individually cutting each of the EO membrane 1, electrodes 2, 3 and additional layers 6, 7. The electrodes 2, 3 may be coated with the carbon coating 4, 5 before or after being cut to the desired size for the application.

Once the components are appropriately sized they are aligned and attached together to form the structure.

So as to prevent a short circuit due to the conductive electrodes 2, 3 coming into electrical contact the porous layer 1 is sized to be larger than the electrodes.

This method of manufacture is expensive, as it will take an operator an estimated 12 minutes per panel to manufacture, or would require large investments in order to automate. However, such a structure may reliably ensure that there is not a short circuit between the electrodes 2, 3. Such a method of manufacture may be acceptable in low or medium volume applications.

Alternatively to this structure and method for minimising the risk of a short circuit, the inventors have further realised that by having one or both of the electrodes have an insulating region facing the porous layer, manufacture can be simplified (and thus made cheaper). This is because the structure can be made by making large electroosmotic structures that can be cut to the desired size at the regions that are insulating without risking creating a short circuit between the electrodes.

FIG. 2 shows an exemplary layered structure 10 in which the electrodes comprise conductive regions 8 and non-conductive regions (i.e. insulating regions) 9. The non-conductive regions 9 are at least non-conductive on the surface of the electrode 2, 3, that faces the porous layer 1.

The layered structure can be cut through the insulating regions 9 (as indicated by the dotted lines) to form a plurality of panels 11. Due to the presence of the insulating regions 9 the risk of there being a short circuit between the electrodes 2, 3 at the cut surface may be significantly reduced. This is because the first electrode and second electrode 2,3 are not in electrical contact with the edge region of the porous layer 1.

FIG. 3 shows a layered structure 20 that further compared to FIG. 2 comprises a carbon coating 4, 5 on the electrodes 2, 3 and additional outer layers 6, 7. Due to the presence of the insulating regions 9 this structure can safely be cut into panels 21 comprising the porous layer 1, electrodes 2, 3 and carbon coating 4, 5 and additional layers 6, 7 without risk of a short circuit.

FIG. 4 shows a variation of the electroosmotic structure 30 in which only one of the electrodes 2 comprises insulating regions 9. Such a structure 30 can still safely be cut into panels 31 without risk of a short circuit between the electrodes 2, 3 at the cut edge.

FIG. 5 shows another variation of the electroosmotic structure 40. In this structure 40 the electrodes 2, 3 each comprise a conductive layer 8 and a non-conductive layer 12, 13. The non-conductive layers 12, 13 are attached to the respective conductive layers 8 to form an electrode with a region facing the porous layer 1 that is insulating. As shown most clearly in FIG. 6 that shows an exploded version of the components of the structure 40, the non-conductive layers may be a frame/grid of material, i.e. a layer with apertures therethrough. Alternatively the non-conductive layers 12, 13 may be provided by a coating that is coated onto the conductive layers 8. The non-conductive layers 12, 13 provide insulating regions through which the structure can be cut to form panels 41 without risk of a short circuit between the conductive parts of the two electrodes 2, 3. A carbon coating 4, 5 may be provided between the conductive layer 8 and non-conductive layer 12, 13 of the electrodes 2, 3.

FIG. 7 shows another variation 50 in which only one of the electrodes 2 comprises a layer 12 that creates insulating regions. Despite the insulating regions only being on one electrode 2 the structure 50 can still be cut into panels 51 without risk of a short circuit between the electrodes 2, 3.

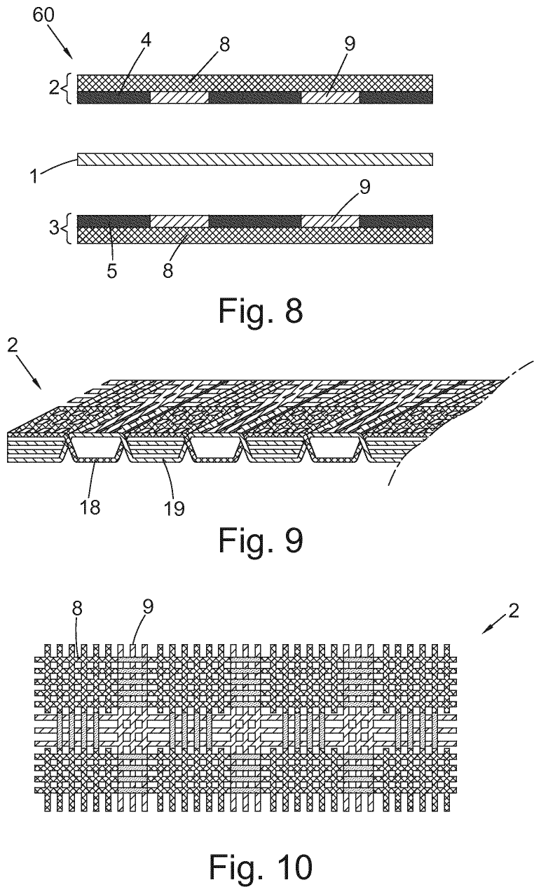

FIG. 8 shows another variation 60. In this case the insulating regions 9 are provided by an insulating coating deposited on the conductive layers 8 of the electrodes 2, 3. In this case there may be carbon coating 4, 5 deposited between the regions with the insulating coating.

FIGS. 9 and 10 illustrate an exemplary electrode 2 that is formed from a weave of conductive fibres 18 and non-conductive fibres 19. The fibres are woven such that on one surface of the electrode there are conductive regions 8 and non-conductive regions 9. The non-conductive regions 9 can provide a cutting zone through which a structure formed with such an electrode 2 can be cut without risk of forming a short circuit.

FIG. 11 illustrates a method of manufacturing an electroosmotic structure 70 that can be cut into panels 71 without risk of the conductive parts of the electrodes 2, 3 coming into contact.

The method comprises providing a plurality of rolls of material wherein there is one roll with material for forming the porous layer 1, and two rolls for forming each of the electrodes 2, 3. One roll for forming the electrodes provides a layer of conductive material 8 and one roll provides a non-conductive layer 12, or 13 with apertures therethrough. The material from the plurality of rolls are laminated together by passing them through laminating rollers 22 to form an electroosmotic layered structure 70. The structure 70 can then be cut into panels 71 using a cutter 24 such as a laser cutter. The presence of the insulating regions on the surface of the electrodes 2, 3 means that the structure 70 can be cut into panels 71 without risk of a short circuit between the electrodes 2, 3.

The roll with material for forming the porous layer 1 may be wider than one or both of the rolls with material for the layer of conductive material 8. This is so at least at the side edges of the formed layered structure the conductive part of the first and/or second electrode is spaced from the edge of the porous layer 1. This is to minimise the risk of a short circuit at the side edges which will not be cut edges.

FIGS. 12 and 13 show an electoosmotic structure 80 in which the conductive regions 8 are electrically connected together by electrical connections 26. This arrangement has on the surface of the electrode(s) 2, 3 that face the porous membrane 1 a region 9 that is insulating through which the material can be cut. The region 9 that is insulating on the surface that faces the porous membrane 1 surrounds the conductive regions 8. This means that a panel 81 can be cut out in which all of the cutting is at a location in which the surface of the electrode that faces the porous membrane 1 is electrically insulating. Thus the panel 81 can have electrodes with multiple conductive regions 9 that face the porous layer 1 that are electrically connected together. This gives the possibility of the electroosmotic structure 80 being cut into panels 81 of various sizes and shapes.

Whilst the figures show a gap between the porous layer 1 and the surfaces of the electrodes 2, 3 (or any coating thereon), this gap is present for clarity purposes. In practice the electrodes 2, 3 will be in contact with or at least very close to the surfaces of the porous layer 1.

1. A layered electroosmotic structure for transporting fluid by electroosmotic transport, the layered structure comprising:
a porous layer, wherein the porous layer is a non-conductive electroosmotic layer;
a first electrode located on a first side of the porous layer; and
a second electrode located on a second side of the porous layer; wherein the first electrode comprises a first surface that faces the porous layer, wherein the first surface of the first electrode comprises a region that is electrically insulating.

2. A layered electroosmotic structure according to claim 1, wherein the first surface of the first electrode comprises a region that is electrically conductive and wherein the region that is electrically insulating provides a greater resistance to the flow of charge than the region that is electrically conductive.

3. A layered electroosmotic structure according to claim 1, wherein the insulating region is provided by the surface of the electrode comprising a non-conductive material.

4. A layered electroosmotic structure according to claim 3, wherein the non-conductive material is a layer of non-conductive material with apertures therethrough that is fixed to a conductive layer to form the electrode.

5. A layered electroosmotic structure according to claim 3, wherein the non-conductive material is a non-conductive coating that is coated onto a conductive material.

6. A layered electroosmotic structure according to claim 1, wherein the first electrode is a fabric formed from conductive and non-conductive fibres, wherein the non-conductive fibres provide the region that is electrically insulating.

7. A layered electroosmotic structure according to claim 1, wherein the structure comprises an edge at which the region that is electrically insulating is located.

8. A layered electroosmotic structure according to claim 1, wherein the second electrode comprises a surface facing the porous layer that has a region that is insulating.

9. A layered electroosmotic structure according to claim 8, wherein the region that is electrically insulating on the first electrode may at least partially overlap the location where the region that is electrically insulating of the second electrode is located.

10. A layered electroosmotic structure according to claim 1, wherein a first surface of the electrode(s) that faces the porous layer comprises a plurality of conductive regions, and wherein the conductive regions are electrically connected at a location other than the first surface of the electrode(s).

11. A method of transporting fluid by electroosmotic transport, the method comprising providing the layered electroosmotic structure of claim 1 and applying a voltage between the two electrodes.

12. A method of manufacturing a layered electroosmotic panel for transporting fluid by electroosmotic transport, the method comprising:
providing a layered electroosmotic structure comprising:
a porous layer;
a first electrode located on a first side of the porous layer; and
a second electrode located on a second side of the porous layer; wherein the first electrode comprises a first surface that faces the porous layer, and wherein the first surface of the first electrode comprises a region that is electrically insulating; and
cutting the layered structure at the region that is electrically insulating of the first surface of the first electrode to form the layered electroosmotic panel.

13. A method according to claim 12, wherein the layered electroosmotic structure is formed by laminating together layers from rolls of material.

14. A method according to claim 12, wherein the layered electroosmotic structure and/or the layered electroosmotic panel is a structure comprising:
a porous layer, wherein the porous layer is a non-conductive electroosmotic layer;
a first electrode located on a first side of the porous layer; and
a second electrode located on a second side of the porous layer; wherein the first electrode comprises a first surface that faces the porous layer, wherein the first surface of the first electrode comprises a region that is electrically insulating.

15. A layered electroosmotic structure for transporting fluid by electroosmotic transport, the layered structure comprising:
a porous layer, wherein the porous layer is a non-conductive electroosmotic layer;
a first electrode located on a first side of the porous layer; and
a second electrode located on a second side of the porous layer; wherein the first electrode and/or second electrode is not in electrical contact with an edge region of the porous layer and in electrical contact with the porous layer at a non-edge region.

16. A layered electroosmotic structure according to claim 15, wherein the first electrode and/or second electrode is not in electrical contact with an edge region of the porous layer because the porous layer extends beyond the edge of the first electrode and/or second electrode.

17. A layered electroosmotic structure according to claim 15, wherein the porous layer is larger than the first electrode and/or second electrode.

18. A layered electroosmotic structure according to claim 15, wherein the first electrode and/or second electrode is not in electrical contact with an edge region of the porous layer because the first electrode and/or second electrode comprises a first surface that faces the porous layer, wherein the first surface of the first electrode and/or second electrode comprises a region that is electrically insulating at the edge region of the porous layer.

19. A layered electroosmotic structure according to claim 15, wherein conductive material of the first electrode and/or second electrode is spaced from an edge of the porous layer and in contact with the porous layer at a non-edge region of the porous layer.

20. (canceled)

21. A method of manufacturing a layered electroosmotic structure for transporting fluid by electroosmotic transport, the method comprising:
providing a porous layer, wherein the porous layer is a non-conductive electroosmotic layer;
providing a first electrode; and
providing a second electrode;
locating the first electrode on a first side of the porous layer and locating the second electrode on a second side of the porous layer to form a layered electroosmotic structure, wherein the first electrode and/or second electrode is not in electrical contact with an edge region of the porous layer and in electrical contact with the porous layer at a non-edge region.

22. (canceled)
